(19) United States
(12) Patent Application Publication
(10) Pub. No.: US 2016/0223829 A1
(43) Pub. Date: Aug. 4, 2016

(54) LENS FRAME, LENS ASSEMBLY AND METHOD OF MANUFACTURING LENS ASSEMBLY

(71) Applicant: OLYMPUS CORPORATION, Tokyo (JP)

(72) Inventor: Norimitsu NAGAYAMA, Tokyo (JP)

(73) Assignee: OLYMPUS CORPORATION, Tokyo (JP)

(21) Appl. No.: 15/097,061

(22) Filed: Apr. 12, 2016

Related U.S. Application Data
(63) Continuation of application No. PCT/JP2014/082582, filed on Dec. 9, 2014.

(30) Foreign Application Priority Data
Dec. 16, 2013 (JP) 2013-259368

(51) Int. Cl. G02B 27/62; G02B 7/02

(52) U.S. Cl. CPC G02B 27/62; G02B 7/025

(57) ABSTRACT

A lens frame which is configured to dispose a lens on a reference axis and fix the lens, the lens frame includes an axial direction reception section configured to abut the lens in the axial direction and separated from the lens upon fixing of the lens in order to define an orientation of the lens with respect to the reference axis, an adhesive agent guide surface configured to form a gap, and an adhesive agent-blocking section formed between the adhesive agent guide surface and the axial direction reception section in the axial direction, fitted onto the side surface of the lens in the radial direction when the lens abuts the axial direction reception section, and configured to block the adhesive agent such that the adhesive agent introduced into the gap does not flow into the axial direction reception section.

This application is a continuation application based on a PCT International Application No. PCT/JP2014/082582, filed on Dec. 9, 2014, whose priority is claimed on Japanese Patent Application No. 2013-259368, filed on Dec. 16, 2013. The contents of the PCT International Application and the Japanese Patent Application are incorporated herein by reference.

### BACKGROUND OF THE INVENTION

1. Field of the Invention

The present invention relates to a lens frame, a lens assembly and a method of manufacturing a lens assembly.

2. Description of Related Art

In the related art, for example, in a lens and a lens frame used in a photographing lens or the like of a digital camera, requirements for part precision may be increased and the part precision may exceed a machining limit of an individual part. For this reason, upon assembly, required optical characteristics are obtained by performing air gap adjustment or eccentricity adjustment of the lens.

For example, in a lens interval adjustment method disclosed in Japanese Unexamined Patent Application, First Publication No. 2010-243961, a spacer tool is inserted through a hole formed at a side of a barrel and the lens is temporarily installed on the spacer tool to adjust an air gap. Further, the spacer tool is moved in a direction perpendicular to an optical axis to perform eccentricity adjustment. Then, as an ultraviolet ray-curing adhesive agent is applied and cured between the lens and an inner circumferential surface of the barrel after adjustment completion and the spacer tool is withdrawn, a lens barrel serving as a lens assembly is formed.

### SUMMARY OF THE INVENTION

According to a first aspect of the present invention, a lens frame which is configured to dispose a lens on a reference axis and fix the lens using an adhesive agent in a state in which a position of the lens is adjusted in an axial direction along at least the reference axis, includes an axial direction reception section configured to abut the lens in the axial direction and separated from the lens upon fixing of the lens in order to define an orientation of the lens with respect to the reference axis; an adhesive agent guide surface configured to form a gap through which the adhesive agent is introduced between a side surface of the lens and the adhesive agent guide surface in a radial direction perpendicular to the reference axis; and an adhesive agent-blocking section formed between the adhesive agent guide surface and the axial direction reception section in the axial direction, fitted onto the side surface of the lens in the radial direction when the lens abuts the axial direction reception section, and configured to block the adhesive agent such that the adhesive agent introduced into the gap does not flow into the axial direction reception section.

According to a second aspect of the present invention, in the lens frame according to the first aspect, the adhesive agent guide surface may be formed such that a region in the axial direction overlaps the side surface of the lens in a position-adjustment range of the lens in the axial direction, when seen from the radial direction, and the axial direction reception section may be formed at a position separated from the lens within the position-adjustment range of the lens in the axial direction.

According to a third aspect of the present invention, a lens assembly includes the lens frame according to the first aspect, and a lens disposed to be spaced from the axial direction reception section of the lens frame in the axial direction and adhered to least one of the adhesive agent guide surface and the adhesive agent-blocking section of the lens frame.

According to a fourth aspect of the present invention, a lens assembly includes the lens frame according to the second aspect, and a lens disposed to be spaced from the axial direction reception section of the lens frame in the axial direction and adhered to least one of the adhesive agent guide surface and the adhesive agent-blocking section of the lens frame.

According to a fifth aspect of the present invention, a method of manufacturing a lens assembly is provided, including: disposing a lens on a reference axis of a lens frame and fixing the lens to the lens frame using an adhesive agent in a state in which a position of the lens is adjusted in an axial direction along at least the reference axis, the lens frame having an axial direction reception section configured to abut the lens in the axial direction, an adhesive agent guide surface having a gap through which the adhesive agent is introduced between a side surface of the lens and the adhesive agent guide surface in a radial direction perpendicular to the reference axis, and an adhesive agent-blocking section fitted onto the side surface of the lens in the radial direction and configured to block the adhesive agent such that the adhesive agent introduced into the gap does not flow into the axial direction reception section, the method of manufacturing the lens assembly including: a lens frame-disposing process of disposing the lens frame to be arranged in sequence of the adhesive agent guide surface, the adhesive agent-blocking section and the axial direction reception section from an upper side; a lens orientation-determining process of performing orientation determination of the lens with respect to the reference axis as the lens abuts the axial direction reception section while fitting the side surface of the lens into the adhesive agent-blocking section; an adhesive agent-holding process configured to introduce the adhesive agent into a gap between the side surface of the lens and the adhesive agent guide surface and hold the adhesive agent blocked by the adhesive agent-blocking section in the gap; a lens position-adjustment process of performing position-adjustment of the lens in the axial direction along at least the reference axis as the lens is separated from the axial direction reception section to move in parallel; and a lens-fixing process of fixing the lens to the lens frame by curing the adhesive agent in a state in which a position and orientation of the lens that passed the position-adjustment are held.

According to a sixth aspect of the present invention, in the method of manufacturing the lens assembly according to the fifth aspect, in the lens position-adjustment process, when the lens is moved above the adhesive agent-blocking section, the position of the lens may be adjusted in the axial direction and the radial direction.

### BRIEF DESCRIPTION OF THE DRAWINGS

FIG. 1A is a schematic cross-sectional view including an optical axis showing an example of a lens assembly according to a first embodiment of the present invention.

FIG. 1B is a left side view of the schematic cross-sectional view including the optical axis showing an example of the lens assembly according to the first embodiment of the present invention.

FIG. 2 is a schematic cross-sectional view including a lens optical axis and showing an example of a lens used in the lens assembly according to the first embodiment of the present invention.

FIG. 3A is a schematic cross-sectional view including a reference axis and showing an example of a lens frame according to the first embodiment of the present invention.

FIG. 3B is a partially enlarged view of portion A of the schematic cross-sectional view including the reference axis and showing an example of the lens frame according to the first embodiment of the present invention.

FIG. 4A is a schematic process illustration view of a lens frame-disposing process and a lens orientation-determining process of a method of manufacturing a lens assembly according to the first embodiment of the present invention.

FIG. 4B is a schematic process illustration view of an adhesive agent-holding process of the method of manufacturing a lens assembly according to the first embodiment of the present invention.

FIG. 5 is a schematic view showing a holding state of an adhesive agent after completion of the adhesive agent-holding process of the method of manufacturing a lens assembly according to the first embodiment of the present invention.

FIG. 6A is a schematic process illustration view of a lens position-adjustment process of the method of manufacturing a lens assembly according to the first embodiment of the present invention.

FIG. 6B is a schematic process illustration view of the lens position-adjustment process of the method of manufacturing a lens assembly according to the first embodiment of the present invention.

FIG. 7 is a partially enlarged view of portion B of FIG. 6B.

FIG. 8 is a schematic process illustration view of a lens-fixing process of the method of manufacturing a lens assembly according to the first embodiment of the present invention.

FIG. 9 is a cross-sectional view showing a configuration of a major part of a lens frame of a first modification of the first embodiment of the present invention.

FIG. 10 is a cross-sectional view showing a configuration of major parts of a lens frame and a lens assembly according to a second embodiment of the present invention.

### DETAILED DESCRIPTION OF THE INVENTION

Hereinafter, embodiments of the present invention will be described with reference to the accompanying drawings. In the drawings, the same or corresponding members are designated by the same reference numerals, and common description thereof will be omitted.

### First Embodiment

A lens frame and lens assembly according to a first embodiment of the present invention will be described.

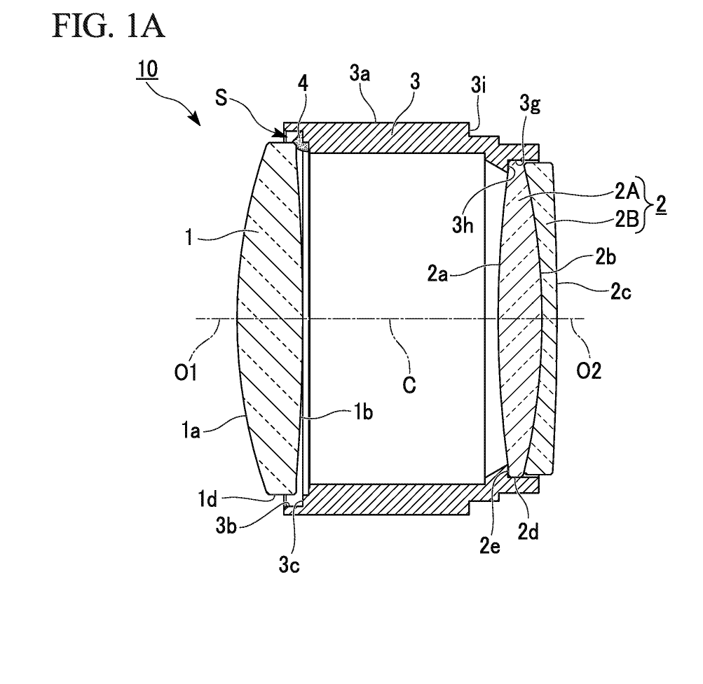

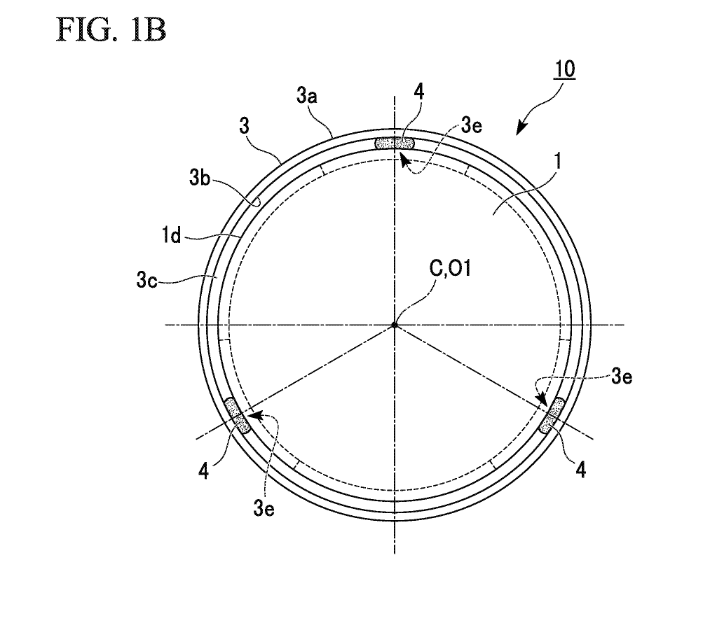

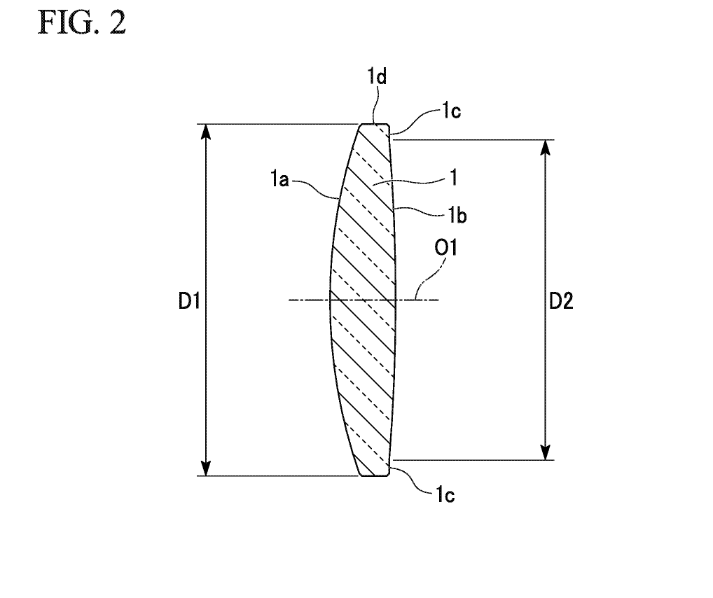

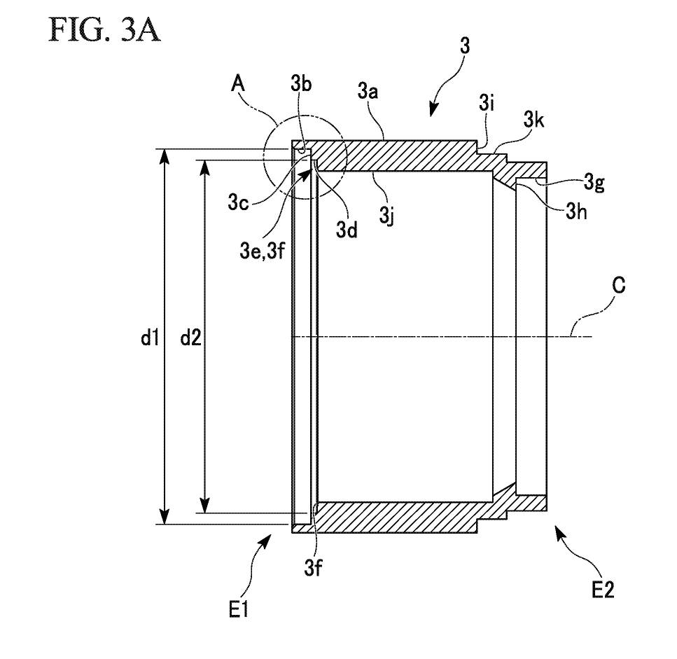

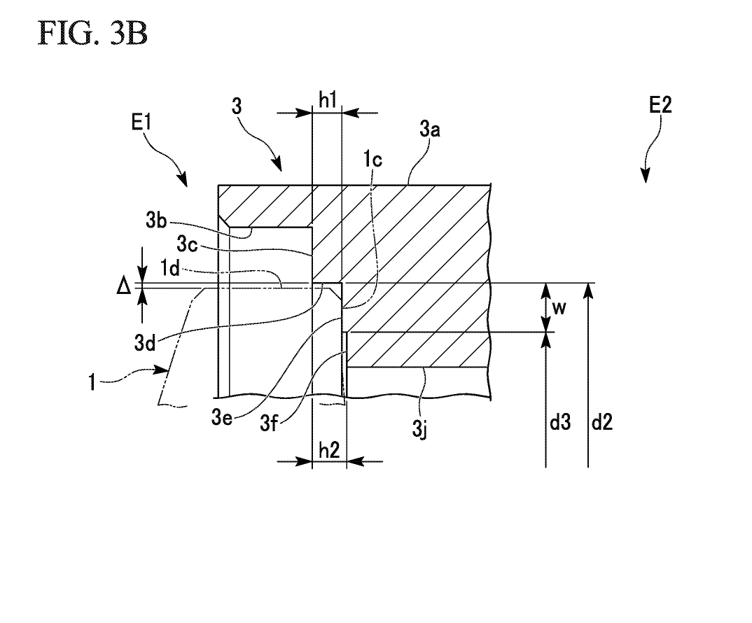

FIG. 1A is a schematic cross-sectional view including an optical axis showing an example of a lens assembly according to the first embodiment of the present invention. FIG. 1B is a left side view of the schematic cross-sectional view including the optical axis of the example of the lens assembly according to the first embodiment of the present invention. FIG. 2 is a schematic cross-sectional view including a lens optical axis and showing an example of a lens used in the lens assembly according to the first embodiment of the present invention. FIG. 3A is a schematic cross-sectional view including a reference axis and showing an example of a lens frame according to the first embodiment of the present invention. FIG. 3B is a partially enlarged view of portion A of the schematic cross-sectional view including the reference axis and showing an example of the lens frame according to the first embodiment of the present invention.

As shown in FIGS. 1A and 1B, a lens unit 10 according to the embodiment is a lens assembly including a first lens 1 (a lens), a second lens 2 and a lens frame 3.

The first lens 1 and the second lens 2 are substantially coaxially disposed (including a situation that the first lens 1 and the second lens 2 are disposed on the same axis), and fixed to the lens frame 3 in a state in which a position of the first lens 1 is adjusted with respect to the second lens 2.

In the embodiment, a position-adjustment of the first lens 1 may be any one of a position-adjustment in a direction along a reference axis C defined by a central axis of the lens frame 3 and a position-adjustment in a direction perpendicular to the reference axis C.

The “lens assembly” is an assembly of a set in which a lens is fixed to a lens frame. The lens assembly may be, for example, an interchangeable lens that constitutes a product itself, or may be a partial assembly embodied only by a process of manufacturing a half-finished product such as an interchangeable unit or the like that constitutes a portion of the product. For example, when a movable lens group and a fixed lens group of a zoom lens are fixed to individual lens frames, a barrel unit including the movable lens group and a barrel unit including the fixed lens group constitute lens assemblies.

Usage of the lens unit 10 is not particularly limited. For example, the lens unit 10 may be used in an appropriate optical instrument such as a lens or the like used in a photographing lens of a digital camera, a microscope, or an endoscope.

Although the lens unit 10 is constituted including, for example, the first lens 1 and the second lens 2 as shown in FIG. 1A, the lens unit 10 is not limited thereto and may employ an appropriate lens configuration according to a use. For example, the first lens 1 may be changed with a cemented lens having an appropriate configuration, the second lens 2 may be changed with a single lens, or at least one lens or lens group may be added between the first lens 1 and the second lens 2.

As shown in FIG. 2, the first lens 1 has a first lens surface 1a and a second lens surface 1b, and cylindrical lens side surfaces 1d (side surfaces of the lenses) are formed at outer circumferences of these.

A lens optical axis O1 of the first lens 1 is aligned on the same axis as a central axis of the lens side surface 1d.

An axial direction reference surface 1c serving as a position reference in a direction along the lens optical axis O1 in the first lens 1 is formed in an outer circumferential portion of the second lens surface 1b.

In the embodiment, the axial direction reference surface 1c is formed between an outer edge portion of the second lens surface 1b and the lens side surface 1d in an annular shape constituted by a plane perpendicular to the lens optical axis O1.

Hereinafter, an outer diameter of the lens side surface 1d is represented as D1 and an outer diameter of the second lens surface 1b is represented as D2 (here, D2<D1). In the embodiment, since the lens side surface 1d is a maximum outer circumferential surface of the first lens 1, the outer diameter D1 is equal to an outer diameter of the first lens 1.

For this reason, the axial direction reference surface 1c is formed in an annular shape in which a width is (D1−D2)/2.

Shapes of the first lens surface 1a and the second lens surface 1b are not particularly limited but, for example, may employ appropriate surface shapes such as a spherical surface, a non-spherical surface, a free form surface, a plane, and so on.

Hereinafter, as an example, the first lens 1 will be described as a case of a biconvex lens.

A material of the first lens 1 may be glass or a synthetic resin. In addition, the method of manufacturing the first lens 1 is not particularly limited, but in the case of the glass, the first lens 1 may be formed by, for example, glass molding, glass polishing, and in the case of a synthetic resin, the first lens 1 may be formed by, for example, injection molding or the like.

A lens configuration of the second lens 2 is not particularly limited as long as the second lens 2 is previously fixed to the lens frame 3 when the second lens 2 constitutes an optical system having an appropriate use together with the first lens 1 and performs an adjustment of the first lens 1. In addition, like the first lens 1, a material or a production method of the second lens 2 is also not particularly limited.

In the embodiment, as an example, the second lens 2 is constituted by the cemented lens as shown in FIG. 1A. That is, the second lens 2 is a cemented lens in which a convex lens 2A formed of a biconvex lens and a concave lens 2B are adhered. The concave lens 2B is constituted by a concave meniscus lens which has a concave surface having the same curvature as one convex surface of the convex lens 2A.

For this reason, the second lens 2 has a first lens surface 2a, a second lens surface 2b and a third lens surface 2c. The first lens surface 2a is constituted by a convex surface of an outer side of the convex lens 2A. The second lens surface 2b is constituted by surfaces in which the convex lens 2A and the concave lens 2B are adhered. The third lens surface 2c is constituted by a convex surface of the concave lens 2B.

An outer diameter of the convex lens 2A is larger than an outer diameter of the concave lens 2B. For this reason, a lens side surface 2d serving as a side surface of the convex lens 2A constitutes an outer circumferential surface having a maximum outer diameter in the second lens 2. In the embodiment, as an example, an outer diameter of the lens side surface 2d is smaller than an outer diameter of the first lens 1.

A lens optical axis O2 of the second lens 2 is aligned to the same axis as the central axis of the lens side surface 2d.

An axial direction reference surface 2e serving as a position reference in a direction along the lens optical axis O2 in the second lens 2 is formed at an outer circumferential portion of the first lens surface 2a.

In the embodiment, the axial direction reference surface 2e is formed between an outer edge portion of the first lens surface 2a and the lens side surface 2d in an annular shape constituted by a plane perpendicular to the lens optical axis O2.

As shown in FIGS. 3A and 3B, the lens frame 3 has a substantially cylindrical member having an outer circumferential surface 3a formed at a side surface thereof and constituted by a cylindrical surface having a diameter larger than the first lens 1. A central axis of the outer circumferential surface 3a coincides with the reference axis C. The reference axis C is an axis of a target configured to align an optical axis as the lens unit 10.

A hole section configured to fix the first lens 1 is formed in a first end portion E1 (a left side of FIGS. 3A and 3B, hereinafter, referred to as the first end portion E1) of the lens frame 3. As shown in FIG. 3B, the hole section includes a lens-holding hole inner circumferential surface 3b (an adhesive agent guide surface), a plane portion 3c, a fitting surface 3d (an adhesive agent-blocking section), an axial direction reception section 3e and an clearance section 3f.

The lens-holding hole inner circumferential surface 3b is constituted by a cylindrical surface having a diameter d1 and provided at the same axis as the reference axis C.

The diameter d1 is set to satisfy d1>D1+2·εₘₐₓ.

εₘₐₓ is a maximum value of a position-adjustment range from the reference axis C in a direction (hereinafter, it may be referred to as a radial direction) perpendicular to the reference axis C of the first lens 1.

A magnitude of εₘₐₓ can be obtained from a condition for correcting deterioration of optical characteristics by a movement of the first lens 1. Deterioration of the optical characteristics occurs due to a combination of unevenness of eccentricity by a machining error of the first lens 1 and the second lens 2 and an eccentricity of the second lens 2 with respect to the reference axis C when the second lens 2 is fixed to the lens frame 3. A specific magnitude of εₘₐₓ can be obtained by, for example, optical simulation or the like.

A length in a direction (hereinafter, it may be referred to as an axial direction) along the reference axis C of the lens-holding hole inner circumferential surface 3b is set to a length of a portion in the radial direction in which an overlap of the lens-holding hole inner circumferential surface 3b and the lens side surface 1d occurs in an adjustment range in the axial direction of the first lens 1 when seen from the radial direction.

By a shape of the above-mentioned lens-holding hole inner circumferential surface 3b, the first lens 1 can be disposed inside the lens-holding hole inner circumferential surface 3b in a state in which the lens side surface 1d is opposite to the lens-holding hole inner circumferential surface 3b with a gap in the radial direction in a position-adjustment range in the axial direction and the radial direction.

The plane portion 3c is a plane portion perpendicular to the reference axis C and extends inward in the radial direction from an end portion of the lens-holding hole inner circumferential surface 3b to a second end portion E2 (a right side of the drawing, hereinafter, referred to as the second end portion E2) of the lens frame 3.

The second end portion E2 is an end portion opposite to the first end portion E1 in the axial direction of the lens frame 3.

The fitting surface 3d is a cylindrical surface having a diameter d2 (here, d2>D1) to movably fit the first lens 1 thereinto in the axial direction. The fitting surface 3d extends from the plane portion 3c toward the second end portion E2 at a position serving as substantially the same axis as the reference axis C (including a situation that the fitting surface 3d and the reference axis C share same axis).

The fitting surface 3d may be preferably formed at a position coaxial to the reference axis C to maintain an adhesive agent, which will be described below, such that a holding state of the adhesive agent is hard to be biased. However, when the bias of the holding state of the adhesive agent is within an allowable range, the fitting surface 3d may also be formed at a position that is eccentric with the reference axis C.

A value of the diameter d2 is set such that a dimension of the gap between the lens side surface 1d and the fitting surface 3d formed when the lens side surface 1d of the first lens 1 is fitted into the fitting surface 3d can block the adhesive agent, which will be described below.

As shown in FIG. 3B, the axial direction reception section 3e and the clearance section 3f sequentially extend to an end portion of the fitting surface 3d close to the second end portion E2. The axial direction reception section 3e is constituted by a plane in which a distance from the plane portion 3c to the inside in the radial direction is h1. The clearance section 3f is formed to prevent contact with the first lens 1.

The axial direction reception section 3e is a reference surface configured to perform orientation determination of the first lens 1 with respect to the reference axis C. As the axial direction reference surface 1c of the first lens 1 abuts the axial direction reception section 3e in the axial direction, orientation determination of the first lens 1 with respect to the reference axis C can be performed.

In the present embodiment, the axial direction reception section 3e is formed to be perpendicular to the reference axis C, and an error of perpendicularity with respect to the reference axis C is within an allowable range of tilt eccentricity of the first lens 1.

As shown in FIG. 3B, the axial direction reception section 3e is formed in an annular region having a diameter equal to or larger than d3 (here, d2>d3>D2) and equal to or smaller than d2 about the reference axis C. For this reason, the axial direction reception section 3e can reliably abut only the axial direction reference surface 1c of the first lens 1 fitted into the fitting surface 3d.

The axial direction reception section 3e can be formed as an annular plane portion having an inner diameter of d3 and an outer diameter of d2 along the entire circumference of the fitting surface 3d.

To reduce unevenness of the abutting state with the axial direction reference surface 1c, the axial direction reception sections 3e may be formed at three places spaced apart from each other in the circumferential direction to obtain a state as close to three-point reception as possible. In addition, when the axial direction reception sections 3e are formed at three places spaced apart from each other in the circumferential direction, in particular, the axial direction reception sections 3e are preferably formed at positions to divide the circumferential direction into three parts.

When the plurality of axial direction reception sections 3e are formed to be spaced apart from each other in the circumferential direction, the positions at which the axial direction reception sections 3e are formed are preferably disposed to correspond to portions to which the adhesive agent, which will be described below, is applied.

In the embodiment, an example in which the axial direction reception sections 3e are formed at three places that divide a circumference into three parts along the fitting surface 3d in an arc shape having a radial direction width of w=(d2−d3)/2 and a central angle of 50° will be exemplarily described.

The distance h1 from the axial direction reception section 3e to the plane portion 3c is a distance at which the axial direction reference surface 1c of the first lens 1 is disposed closer to the first end portion E1 than the plane portion 3c when the first lens 1 is moved within a position-adjustment range which will be described below. That is, the distance h1 is set to have a positional relation in which the lens side surface 1d and the fitting surface 3d do not oppose each other when the first lens 1 is moved within the position-adjustment range.

The clearance section 3f is not particularly limited as long as the axial direction reference surface 1c and the second lens surface 1b of the first lens 1 are formed not to abut each other at a position other than the axial direction reception section 3e when the axial direction reference surface 1c of the first lens 1 abuts the axial direction reception section 3e.

In the embodiment, as an example, the clearance section 3f is constituted by a plane in which a distance from the plane portion 3c is h2 (here, h2>h1).

The clearance section 3f is also formed in the circumferential direction between neighboring axial direction reception sections 3e. For example, as shown in FIG. 3A, only the clearance section 3f is formed between an area (an upper side of the drawing) at which the axial direction reception section 3e is formed and an area (a lower side of the drawing) opposite thereto with the reference axis C sandwiched therebetween to extend from the end portion of the fitting surface 3d.

A cylindrical frame inner circumferential surface 3j extending to the vicinity of the second end portion E2 in the axial direction is formed at an inner circumferential side of the clearance section 3f.

A hole section configured to fix the second lens 2 is formed in the second end portion E2 of the lens frame 3. The hole section includes a lens-holding hole inner circumferential surface 3g and a lens receiving section 3h.

The lens-holding hole inner circumferential surface 3g holds the second lens 2 as the lens-holding hole inner circumferential surface 3g is fitted onto the lens side surface 2d of the second lens 2 to be positioned in the radial direction. The lens-holding hole inner circumferential surface 3g is constituted by a cylindrical surface formed coaxially with the reference axis C.

The lens receiving section 3h fixes a position thereof in the axial direction as the lens receiving section 3h abuts the axial direction reference surface 2e of the second lens 2 in the axial direction. The lens receiving section 3h is constituted by an annular plane constituted by a plane perpendicular to the reference axis C. However, like the axial direction reception section 3e, the lens receiving section 3h may be constituted by plane portions separated from each other in the circumferential direction.

A width in the radial direction of the lens receiving section 3h is set to an appropriate width smaller than the width in the radial direction of the axial direction reference surface 2e of the second lens 2.

A stepped section having a diameter smaller than that of the outer circumferential surface 3a is formed at an outer circumferential portion of the second end portion E2 by an axial direction reference surface 3i and a cylindrical surface 3k.

The axial direction reference surface 3i is a position reference surface in the axial direction of the lens frame 3 and constituted by a plane perpendicular to the reference axis C.

The cylindrical surface 3k is a cylindrical surface formed concentrically with the reference axis C and having a diameter smaller than that of the outer circumferential surface 3a.

As shown in FIG. 1A, the lens unit 10 having the above-mentioned configuration is fixed in a state in which the second lens 2 is fitted into the hole section of a second end portion E2 side, and adhered and fixed in a state in which a position of the first lens 1 is adjusted at the hole section of a first end portion E1 side.

A fixing method of the second lens 2 and the lens frame 3 is not particularly limited but, for example may be adhesion, caulking, fixing by a presser ring screwed onto the lens frame 3, and so on.

In the embodiment, as an example, the second lens 2 and the lens frame 3 are fixed by applying and curing an adhesive agent (not shown) between a side surface of the second lens 2 and the lens-holding hole inner circumferential surface 3g.

The first lens 1 and the lens frame 3 are fixed by at least an adhesive agent curing body 4 being formed. The adhesive agent curing body 4 is formed by a method of manufacturing a lens assembly of the embodiment, which will be described below, between the outer circumferential portion of the second lens 2 and the lens-holding hole inner circumferential surface 3b or the plane portion 3c.

The adhesive agent that forms the adhesive agent curing body 4 is not particularly limited as long as the adhesive agent enables adhesion of the first lens 1 and the lens frame 3. The adhesive agent appropriate for formation of the adhesive agent curing body 4 may be, for example, an ultraviolet ray (UV) curing type adhesive agent, a two-liquid type adhesive agent, a thermosetting adhesive agent, and so on.

The lens unit 10 can be manufactured by the method of manufacturing a lens assembly after formation of the first lens 1, the second lens 2 and the lens frame 3.

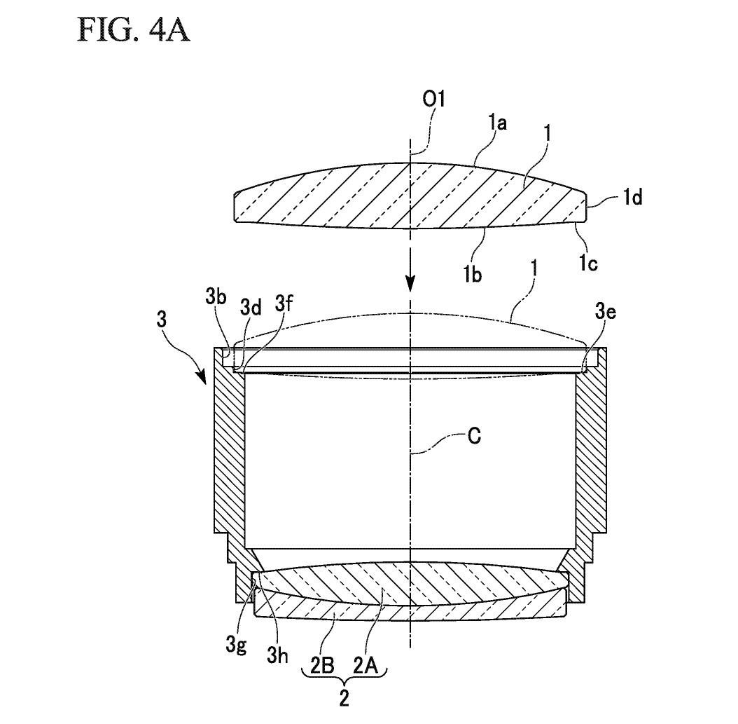

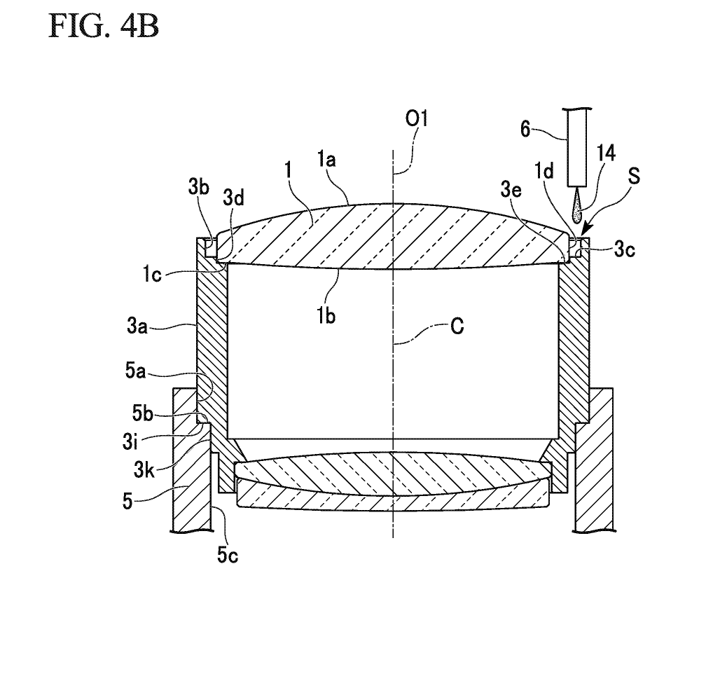

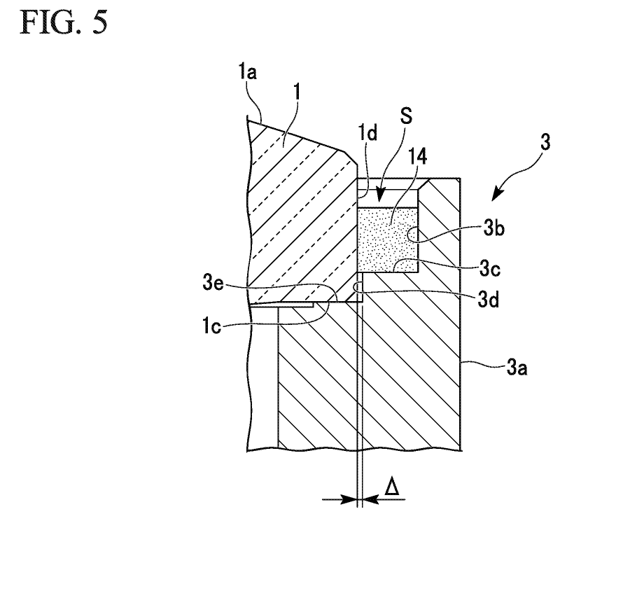

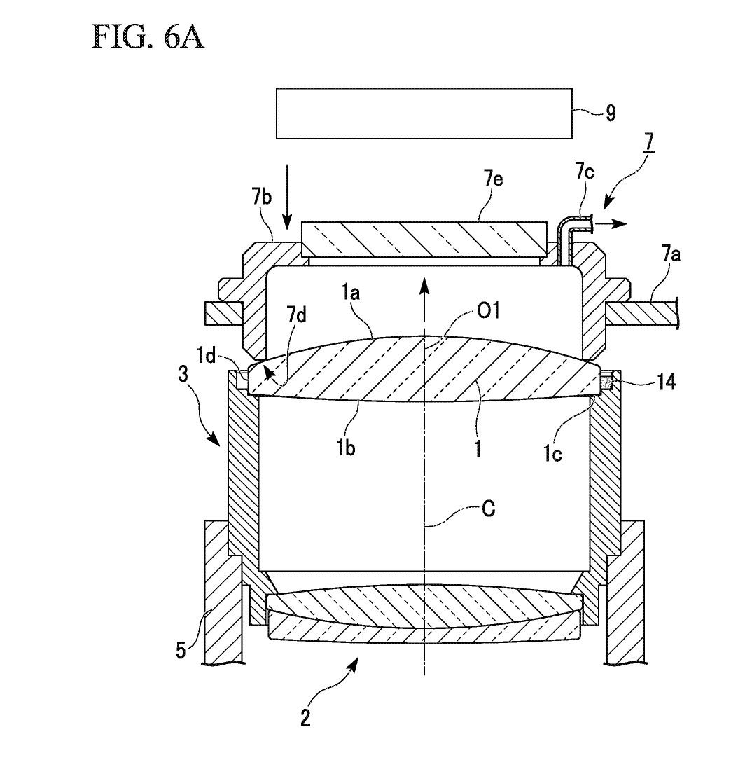

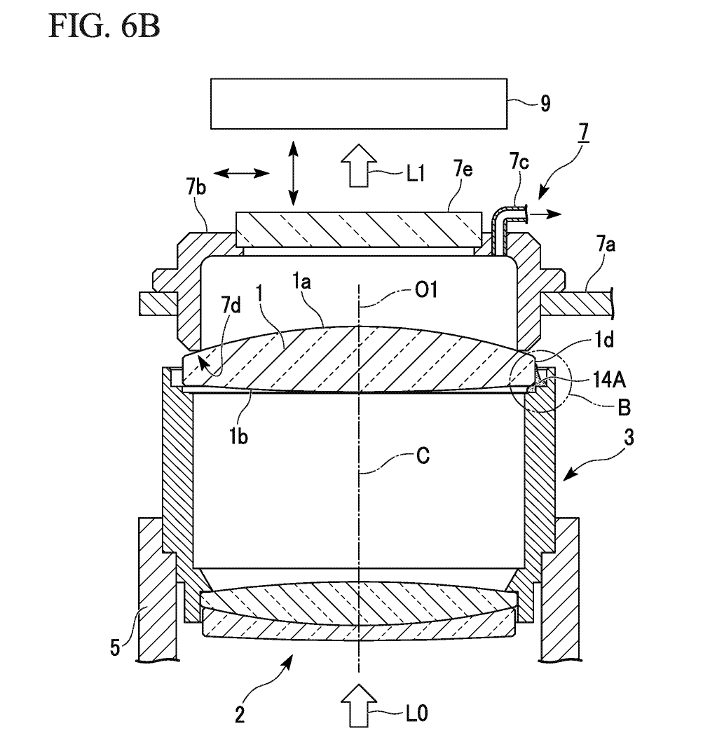

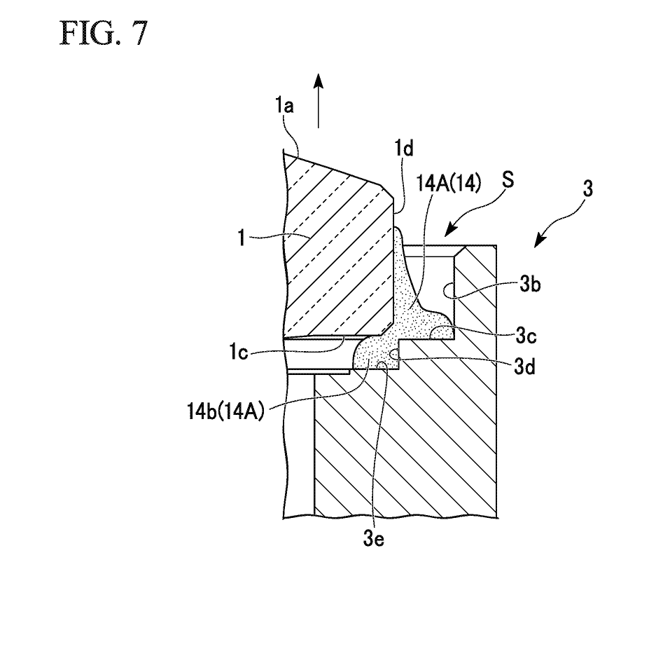

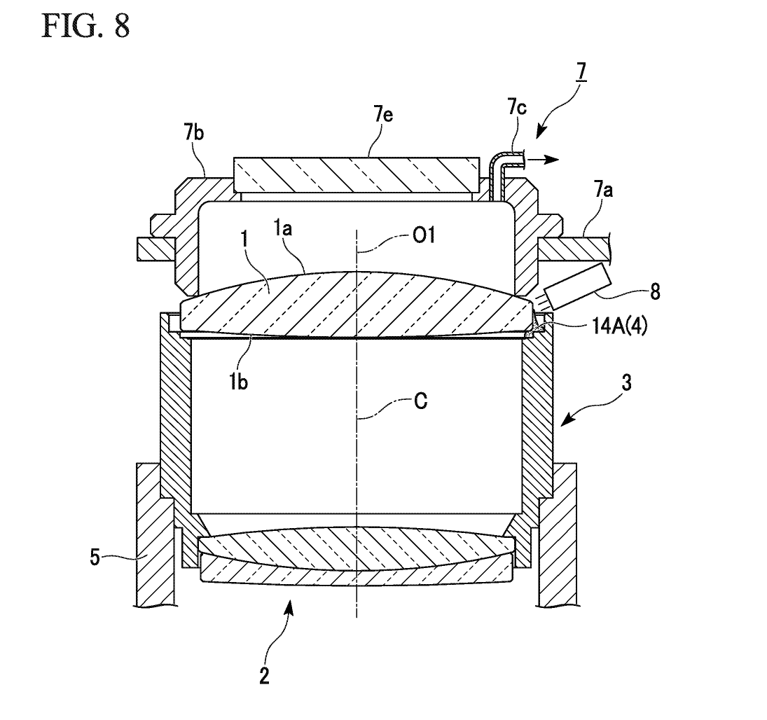

FIG. 4A is a schematic process illustration view of a lens frame-disposing process and a lens orientation-determining process of a method of manufacturing a lens assembly according to the first embodiment of the present invention. FIG. 4B is a schematic process illustration view of an adhesive agent-holding process of the method of manufacturing a lens assembly according to the first embodiment of the present invention. FIG. 5 is a schematic view showing a holding state of an adhesive agent after completion of the adhesive agent-holding process of the method of manufacturing a lens assembly according to the first embodiment of the present invention. FIG. 6A is a schematic process illustration view of a lens position-adjustment process of the method of manufacturing a lens assembly according to the first embodiment of the present invention and FIG. 6B is a schematic process illustration view of the lens position-adjustment process of the method of manufacturing a lens assembly according to the first embodiment of the present invention. FIG. 7 is a partially enlarged view of portion B of FIG. 6B. FIG. 8 is a schematic process illustration view of a lens-fixing process of the method of manufacturing a lens assembly according to the first embodiment of the present invention.

The method of manufacturing a lens assembly according to the embodiment includes the lens frame-disposing process, the lens orientation-determining process, the adhesive agent holding process, the lens position-adjustment process and the lens-fixing process, and these processes are performed in the above-mentioned sequence.

First, the lens frame-disposing process is performed. The process disposes a hole section of the first end portion E1 side upward after the second lens 2 is fixed to the lens frame 3. That is, as shown in FIG. 4A, the lens frame 3 to which the second lens 2 is fixed is disposed such that the lens-holding hole inner circumferential surface 3b serving as an adhesive agent guide surface, the fitting surface 3d serving as an adhesive agent-blocking section, and the axial direction reception section 3e are sequentially arranged from the upper side.

A holding means of the lens frame 3 is not particularly limited, but the lens frame 3 can be held by an appropriate tool or the like (not shown). In addition, the lens frame 3 can also be held by a receptacle frame 5, which will be described below.

As a result, the lens frame-disposing process is terminated.

Next, the lens orientation-determining process is performed. The process performs orientation-determining of the first lens 1 with respect to the reference axis C by causing the axial direction reference surface 1c of the first lens 1 to abut the axial direction reception section 3e while the lens side surface 1d of the first lens 1 is fitted into the fitting surface 3d.

That is, the second lens surface 1b of the first lens 1 is directed downward, and the first lens 1 is inserted into the fitting surface 3d. The first lens 1 is placed on the axial direction reception section 3e by its own weight, and the axial direction reference surface 1c abuts the axial direction reception sections 3e.

Accordingly, the axial direction reference surface 1c of the first lens 1 is aligned to a plane determined by the axial direction reception sections 3e, orientation of the first lens 1 with respect to the reference axis C is defined, and the orientation-determining process is terminated (see two-dot chain line of FIG. 4A).

In the embodiment, since the axial direction reference surface 1c is formed to be perpendicular to the lens optical axis O1 within an allowable error range, the lens optical axis O1 of the first lens 1 is substantially parallel to (including a case of parallelism) the reference axis C.

An allowable error of perpendicularity of the lens optical axis O1 with respect to the axial direction reference surface 1c and an allowable error of perpendicularity of the axial direction reception section 3e with respect to the reference axis C are predetermined by performing optical simulation or the like. Specifically, the above-mentioned allowable errors are determined from a condition in which deterioration of optical characteristics of the lens unit 10 can be corrected only by position-adjustment in the radial direction and the axial direction of the first lens 1. Deterioration of the optical characteristics of the lens unit 10 occurs due to unevenness of the position and orientation of the lens optical axis O2 of the second lens 2 fixed to the lens frame 3.

As a result, the lens orientation-determining process is terminated.

Next, the adhesive agent-holding process is performed. As shown in FIG. 4B, this process introduces an adhesive agent 14 into a gap S between the lens side surface 1d and the lens-holding hole inner circumferential surface 3b, and holds the adhesive agent 14 blocked by the fitting surface 3d in the gap S.

In the embodiment, processes subsequent to the process are performed after the second lens 2 is fixed and the lens frame 3 that holds the first lens 1 in an orientation-determined state is moved to the receptacle frame 5 as shown in FIG. 4B.

The receptacle frame 5 is a substantially cylindrical member, an upper side of which is open. The receptacle frame 5 has a holding section 5a, a receiving section 5b and a hole section 5c. The holding section 5a holds an end portion of the outer circumferential surface 3a of the lens frame 3 close to the second end portion E2 at an upper end portion thereof in the radial direction. The receiving section 5b receives the axial direction reference surface 3i of the lens frame 3 from below. The hole section 5c is formed to pass through the inner circumferential section of the receiving section 5b.

The holding section 5a has a configuration in which the lens frame 3 is held in a state in which the holding section 5a is positioned in the radial direction. The holding section 5a is constituted by a hole section and a chucking mechanism. The hole section is detachably fitted to the outer circumferential surface 3a without rattling of the lens frame 3. A chucking mechanism chucks the outer circumferential surface 3a of the lens frame 3 in the radial direction.

The receiving section 5b is a portion configured to position the lens frame 3 in the axial direction and integrally formed with the holding section 5a.

The hole section 5c is a cylindrical hole section formed at a position on the same axis as the holding section 5a and formed to have a diameter larger than that of the cylindrical surface 3k of the lens frame 3.

While not particularly shown, a sensor, a light source, or the like, configured to measure optical characteristics may be disposed in the hole section 5c according to necessity in the lens position-adjustment process, which will be described below.

As shown in FIG. 4B, when the lens frame 3 is held by the holding section 5a, an adhesive agent supply unit 6 is disposed above the receptacle frame 5.

The adhesive agent supply unit 6 is an apparatus portion configured to supply the adhesive agent 14 as the adhesive agent 14 is dropped downward from an end portion of a needle-shaped supply pipe. The adhesive agent supply unit 6 is installed to advance and retreat to an upper side of the receptacle frame 5 and to be rotatable about the reference axis C.

Hereinafter, a case in which the adhesive agent 14 is a UV curing type adhesive agent will be exemplarily described.

A viscosity of the adhesive agent 14 is set to satisfy the following conditions. That is, even when a maximum gap Δₘₐₓ=d2−D1 is formed between the fitting surface 3d and the lens side surface 1d, the adhesive agent 14 is blocked between the fitting surface 3d and the lens side surface 1d and does not flow on the axial direction reception section 3e.

Since the viscosity of the adhesive agent 14 is determined according to a material of the first lens 1 and the lens frame 3 and a length in the axial direction of the gap, an appropriate viscosity can be obtained without pre-performing an experiment.

For example, a material of the first lens 1 is a glass material N-BK7 (Trade name: manufactured by SCHOTT AG), a material of the lens frame 3 is polycarbonate, and a length in the axial direction of the gap between the fitting surface 3d and the lens side surface 1d is 0.3 mm. In this case, the viscosity of the adhesive agent 14 is preferably 5 Pa·s to 30 Pa·s when the maximum gap Δₘₐₓ is 0.05 mm, and 20 Pa·s to 40 Pa·s when the maximum gap Δₘₐₓ is 0.1 mm.

When the viscosity of the adhesive agent 14 is smaller than the above-mentioned lower limit value, the adhesive agent 14 may not be appropriately blocked.

When the viscosity of the adhesive agent 14 is larger than the above-mentioned upper limit value, since a sufficient amount of adhesive agent 14 is not introduced into the gap S, an adhesion error may occur. In addition, as a moving resistance of the first lens 1 is increased upon lens adjustment, which will be described below, a movement error of the first lens 1 may occur.

Next, the adhesive agent supply unit 6 is moved onto the plane portion 3c disposed at a position at which the axial direction reception section 3e is formed, and a predetermined amount of the adhesive agent 14 is dropped from the adhesive agent supply unit 6.

As shown in FIG. 5, the dropped adhesive agent 14 falls onto the plane portion 3c between the lens side surface 1d and the lens-holding hole inner circumferential surface 3b. The dropped adhesive agent 14 is spread in the gap S and held in the gap S according to surface tension and viscosity of the adhesive agent itself. The gap S is constituted by a groove section surrounded by the lens side surface 1d, the plane portion 3c and the lens-holding hole inner circumferential surface 3b.

Here, since a gap Δ between the lens side surface 1d and the fitting surface 3d is 0 or more and Δₘₐₓ or less, the adhesive agent 14 is blocked between the lens side surface 1d and the fitting surface 3d. For this reason, the adhesive agent 14 does not flow onto the axial direction reception section 3e.

Accordingly, the adhesive agent 14 also does not intrude between the axial direction reception section 3e and the axial direction reference surface 1c. In the orientation of the first lens 1, a state in which the axial direction reference surface 1c abuts the axial direction reception section 3e is maintained. That is, intrusion of the adhesive agent 14 between the axial direction reference surface 1c and the axial direction reception section 3e, and variation of the orientation or position of the first lens 1 are prevented.

In this way, the adhesive agent 14 is dropped onto the plane portion 3c in the vicinity of all of the axial direction reception sections 3e that require adhesion and fixation, and the adhesive agent 14 is held in the gap S of the areas.

As a result, the adhesive agent-holding process is terminated.

Next, the lens position-adjustment process is performed. The process adjusts a position of the first lens 1 in at least the axial direction as the first lens 1 is separated from the axial direction reception section 3e and moved parallel thereto.

In performing the process, an operation of determining the moving position of the first lens 1 (hereinafter, referred to as a moving position-determination operation) and an operation of moving the first lens 1 (hereinafter, referred to as a moving operation) should be performed.

As an example of the moving position-determination operation, the following operation may be exemplified. First, optical characteristics of the optical system constituted by the first lens 1 and the second lens 2 are measured in a disposition state of the first lens 1 after completion of the adhesive agent holding process. Next, an optimal moving position of the first lens 1 is calculated from the deviation of the optical characteristics with respect to the optical characteristics on design in the disposition state. As the optical characteristics used for the measurement, transmission eccentricity, imaging characteristics, transmission wave surface, and so on, may be exemplified.

The above-mentioned moving position-determination operation can be performed by radiating an appropriate measurement luminous flux to the lens frame 3 held by the receptacle frame 5 and measuring optical characteristics using an appropriate sensor or measurement apparatus. Calculation for obtaining a moving position of the first lens 1 from the deviation of the optical characteristics can use optical simulation or the like.

In the embodiment, the moving operation is performed by a lens moving apparatus 7 shown in FIG. 6A.

The lens moving apparatus 7 includes an adsorption section 7b and a movable arm 7a. The adsorption section 7b adsorbs the first lens surface 1a of the first lens 1. The movable arm 7a moves the adsorption section 7b together with the first lens 1 adsorbed to the adsorption section 7b.

The adsorption section 7b is a bottomed cylindrical member, a lower side thereof is open, and is fitted into a central portion of a ceiling section such that a light transmission window 7e through which a measurement luminous flux, which will be described below, passes is air-tightly held. A suction pipe 7c connected to a suction pump (not shown) configured to suction the inside of the adsorption section 7b is connected to an outer circumferential portion of the ceiling section of the adsorption section 7b.

The light transmission window 7e is constituted by flat parallel plates formed of glass that does not exert an influence to a transmission wave surface of the measurement luminous flux.

An adsorption section front end 7d that constitutes an opening of the adsorption section 7b is formed to have a shape that comes in line contact with the first lens surface 1a to be adhered thereto.

The movable arm 7a is connected to a moving mechanism (not shown) and movably supported in two axial directions perpendicular to the reference axis C and one axial direction along the reference axis C.

The movable arm 7a holds the adsorption section 7b such that a central axis of the adsorption section front end 7d is aligned concentrically with the reference axis C.

In moving the first lens 1 to the determined moving position using the lens moving apparatus 7, first, as shown in FIG. 6A, the movable arm 7a is moved, the adsorption section 7b is moved onto the first lens surface 1a, and the adsorption section 7b is lowered until the adsorption section front end 7d abuts the first lens surface 1a.

Here, when a center of curvature of the first lens surface 1a is deviated from the reference axis C, the adsorption section front end 7d is not adhered to the first lens surface 1a. However, the first lens 1 is movable in the radial direction along the axial direction reception section 3e within a range of the fitting surface 3d without fitting at this time. For this reason, according to the lowering of the adsorption section front end 7d, the first lens 1 moves such that the first lens surface 1a follows the adsorption section front end 7d. Accordingly the first lens 1 moves parallel to the radial direction to be centered such that the adsorption section front end 7d is adhered to the first lens surface 1a.

Since the first lens 1 is centered and the entire circumference of the adsorption section front end 7d is adhered to the first lens surface 1a, suction from the suction pipe 7c is performed and the first lens 1 is adsorbed to the adsorption section 7b.

Next, the movable arm 7a is raised along the reference axis C to a height at which the lens side surface 1d is higher than the fitting surface 3d.

Here, as shown in FIG. 7, the adhesive agent 14 held between the lens side surface 1d and the lens-holding hole inner circumferential surface 3b is partially pulled upward together with the lens side surface 1d.

When the first lens 1 is pulled upward above the fitting surface 3d and the gap between the outer circumferential portion of the first lens 1 and the plane portion 3c is increased to a certain extent, a portion of the adhesive agent 14 moves downward along the fitting surface 3d or the axial direction reception section 3e through the gap to go around and enter below the axial direction reference surface 1c. That is, the adhesive agent 14 held in the gap S becomes, for example, an adhesive agent 14A distributed in a shape as shown in FIG. 7 as a result of such a flow or deformation.

For this reason, the first lens 1 is separated from the axial direction reception section 3e and the plane portion 3c with a portion of the adhesive agent 14A sandwiched therebetween.

Even when the adhesive agent 14A goes around and enters below the axial direction reference surface 1c, since the first lens 1 is moved in parallel in a state in which the first lens 1 is held by the lens moving apparatus 7, the position or orientation of the first lens 1 is not varied by the wraparound and entrance of the adhesive agent 14A.

When the first lens 1 is pulled upward from the fitting surface 3d, the first lens 1 is movable in a region above the plane portion 3c and inside the lens-holding hole inner circumferential surface 3b.

Next, the movable arm 7a is driven and the first lens 1 is moved in parallel to the moving position determined by the moving position-determination operation. Here, although a resistance caused by the viscous force of the adhesive agent 14A is received, since the resistance is reduced when the adhesive agent 14A is moved at an appropriate moving speed, precise movement becomes possible even when the value is small.

As described above, when the moving operation is terminated, the lens position-adjustment process is also terminated.

Although an example of the process has been described, when the optical characteristics are controlled to be measured during movement of the first lens 1, as the moving position-determination operation and the moving operation are switched and repeated, the moving position of the first lens 1 can also be gradually varied.

For example, an initial moving position of the first lens 1 is determined to be a position at which a lens interval with the second lens 2 is a design specification value of the lens unit 10, and the first lens 1 is raised to the position along the reference axis C.

Next, measurement of the optical characteristics is performed in this state, a travel distance of the first lens 1 in the radial direction is calculated to determine the moving position of the first lens 1 based on the deviation from the design value, and the first lens 1 is moved to the moving position.

As an example of the measurement of the above-mentioned optical characteristics, wave surface measurement using a wave surface sensor 9 shown in FIGS. 6A and 6B may be exemplarily described.

The wave surface sensor 9 can employ, for example, a Shack-Hartmann sensor. As an example of the wave surface sensor 9, for example, a wave surface sensor S-cube (Trade name: manufactured by Suruga Seiki Ltd.) may be mentioned.

The Shack-Hartmann sensor includes a micro lens array, an imaging device and an analysis calculation unit, and photographs a condensing spot of a luminous flux entering the micro lens array using an imaging device. The analysis calculation unit obtains collecting positions of the condensing spots by the micro lens array from an image imaged by the imaging device, and obtains an incremental difference between ideal collecting positions of the condensing spot when the luminous flux having an ideal wave surface enters the micro lens array.

For example, as shown in FIG. 6B, when a measured luminous flux L0 serving as an ideal spherical surface wave enters the second lens 2, a case in which a measured luminous flux L1 that passed through the second lens 2 and the first lens 1 is emitted from the lens unit 10 is assumed.

In this case, when the positions or the orientations of the first lens 1 and the second lens 2 are deviated from the position or orientation on lens design, wave surface aberration occurs from the measured luminous flux L1, and the above-mentioned incremental difference occurs.

The analysis calculation unit can analyze these incremental differences using a Zernike polynomial expression, and calculate, for example, a Zernike coefficient and a Seidel aberration calculated from the Zernike coefficient.

The analysis calculation unit can calculate the travel distance of the first lens 1 for reducing the above-mentioned incremental difference from the calculated Zernike coefficient or Seidel aberration to determine the moving position of the first lens 1. Then, the first lens 1 can be moved to the moving position using the lens moving apparatus 7.

As the above-mentioned moving position-determination operation and moving operation are repeated until the deviation from the design values of the optical characteristics is converged to an allowable value or less, position-adjustment of the first lens 1 can also be performed.

The above-mentioned moving position-determination operation and moving operation may be performed by an operator while the operator observes an output value or an output image of the wave surface sensor 9, and a calculation apparatus (not shown) may automatically calculate the moving position of the first lens 1 and control the operation of the lens moving apparatus 7 based on the output value of the wave surface sensor 9.

Next, the lens-fixing process is performed. The process fixes the first lens 1 to the lens frame 3 by curing the adhesive agent 14A in a state in which the position and the orientation of the first lens 1 in which the position-adjustment is terminated is held by the lens moving apparatus 7.

In the embodiment, since the adhesive agent 14A is the UV curing type adhesive agent, as UV light is radiated from a UV light source 8 in a region on which the adhesive agent 14A is applied, the adhesive agent 14A is cured.

The UV light source 8 may be configured to radiate the UV light while sequentially moving application positions of the adhesive agent 14A, or may be configured to simultaneously radiate the UV light to the entire adhesive agent 14A.

Even in both cases, the state in which the first lens 1 is held by the lens moving apparatus 7 is continued until the curing of the entire adhesive agent 14A is terminated. For this reason, even when deformation or the like occurs upon the curing of the adhesive agent 14A, the position or orientation of the first lens 1 is held in a certain state.

When the adhesive agent 14A is cured and the adhesive agent curing body 4 is formed, radiation of the UV light from the UV light source 8 is terminated.

Next, suction of the suction pipe 7c is stopped and the adsorption section 7b is separated from the first lens 1.

Then, the lens-fixing process is terminated.

As described in the above-mentioned processes, the lens unit 10 is manufactured.

Further, in manufacturing another lens unit 10, the receptacle frame 5 is removed from the lens unit 10, the lens frame 3 that passed through the lens frame-disposing process and the lens orientation-determining process is held by the receptacle frame 5, and then, the adhesive agent holding process, the lens position-adjustment process and the lens-fixing process are repeated in the above-mentioned sequence.

According to the method of manufacturing a lens assembly according to the embodiment, the adhesive agent is applied by the lens frame having the axial direction reception section, the adhesive agent guide surface and the adhesive agent-blocking section in a state in which the orientation of the lens is determined, and the position-adjustment of the lens and the curing of the adhesive agent are performed as the orientation-determined lens is moved in parallel. For this reason, when the lens is assembled to the lens frame by adhesion, the position-adjustment of the lens can be precisely performed by a simple configuration without using, for example, a spacer tool or the like configured to perform orientation determination.

### [First Modification]

Next, a lens frame of a first modification of the embodiment will be described.

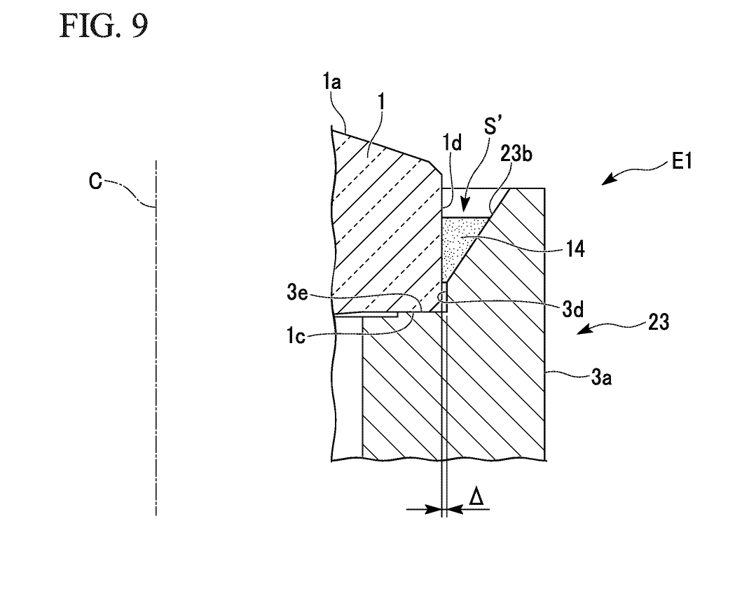

FIG. 9 is a cross-sectional view showing a configuration of a major part of the lens frame of the first modification of the first embodiment of the present invention.

As shown in the major part of FIG. 9, a lens frame 23 according to the present modification does not have the plane portion 3c of the lens frame 3 according to the first embodiment is deleted, and instead of the lens-holding hole inner circumferential surface 3b, a lens-holding hole inner circumferential surface 23b (an adhesive agent guide surface) is provided.

As the lens frame 23 according to the present modification is used instead of the lens frame 3 of the lens unit 10 according to the first embodiment, it is possible to configure the lens assembly in which the first lens 1 and the lens frame 3 according to the first embodiment are fixed like the lens unit 10.

Hereinafter, different points from the first embodiment will be mainly described

The lens-holding hole inner circumferential surface 23b is provided concentrically with the reference axis C and constituted by a tapered surface having a diameter increased from a base end portion connected to an end portion of the fitting surface 3d toward the first end portion E1.

A magnitude of inclination of the lens-holding hole inner circumferential surface 23b is set to a magnitude such that the lens-holding hole inner circumferential surface 23b does not interfere with the first lens 1 within the position-adjustment range of the first lens 1.

A length in the axial direction of the lens-holding hole inner circumferential surface 3b is set to a length at which an overlap with the lens side surface 1d in the radial direction occurs when seen from the radial direction in the adjustment range in the axial direction of the first lens 1.

According to the lens frame 23 according to the present modification, the lens assembly can be manufactured through substantially the same manufacturing method as the method of manufacturing a lens assembly according to the first embodiment.

A difference from the first embodiment is only a holding type of the adhesive agent 14 in the adhesive agent holding process. That is, in the first embodiment, in the adhesive agent holding process, the adhesive agent 14 is held in the gap S having a rectangular cross-sectional shape and surrounded by the lens side surface 1d, the plane portion 3c and the lens-holding hole inner circumferential surface 3b. On the other hand, as shown in FIG. 9, an adhesive agent-holding process according to the present modification differs from the embodiment in that the adhesive agent 14 is held in a V-shaped gap S′ surrounded by the lens side surface 1d and the lens-holding hole inner circumferential surface 23b.

The fact that the adhesive agent 14 is blocked in a gap Δ between the lens side surface 1d and the fitting surface 3d is similar to the first embodiment.

For this reason, like the first embodiment, the adhesive agent is applied in a state in which orientation of the first lens 1 is determined, the orientation-determined first lens 1 is moved in parallel to perform position-adjustment of the first lens 1, and then, an adhesive agent curing body (not shown) can be formed.

Accordingly, when the first lens 1 is assembled to the lens frame 23 by adhesion, the position-adjustment of the first lens 1 can be precisely performed by a simple configuration without using a spacer tool or the like configured to perform orientation determination.

### Second Embodiment

Next, a lens frame and a lens assembly according to a second embodiment of the present invention will be described.

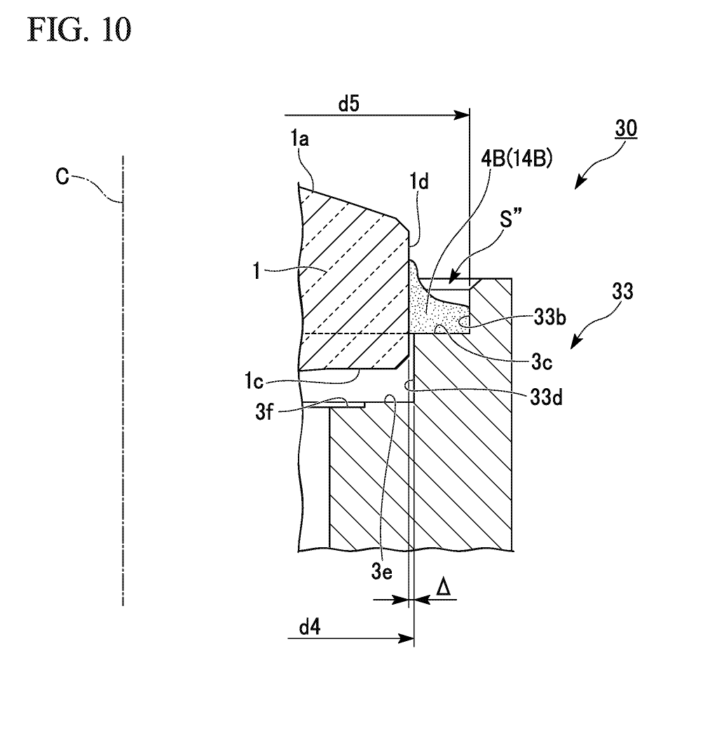

FIG. 10 is a cross-sectional view showing a configuration of a major part of a lens frame 33 and a lens assembly according to the second embodiment of the present invention.

The lens unit 10 according to the first embodiment is an example of the case in which a position of the first lens 1 is fixed as the position of the first lens 1 is adjusted in the axial direction and the radial direction within a range of the lens-holding hole inner circumferential surface 3b.

On the other hand, a lens unit 30 (a lens assembly) according to the second embodiment differs from the first embodiment in that position-adjustment of the first lens 1 is performed only in the axial direction to fix the first lens 1.

For this reason, an eccentricity amount of the second lens 2 is small enough that there is no need to adjust the optical characteristics by making the first lens 1 eccentric, or is adjusted upon fixation thereof.

As shown in the major part of FIG. 10, the lens unit 30 includes the lens frame 33 instead of the lens frame 3 of the lens unit 10 according to the first embodiment.

Hereinafter, points different from the first embodiment will be mainly described.

The lens frame 33 according to the second embodiment includes a fitting surface 33d (an adhesive agent-blocking section) and a lens-holding hole inner circumferential surface 33b (an adhesive agent guide surface), instead of the fitting surface 3d and the lens-holding hole inner circumferential surface 3b of the lens frame 3.

In the first embodiment, when the first lens 1 is moved within the position-adjustment range, the fitting surface 3d has a positional relation that does not oppose the lens side surface 1d. On the other hand, similar to fitting onto the first lens 1, the fitting surface 33d according to the embodiment differs from the first embodiment in that at least a portion of the fitting surface 33d is formed at a position opposite to the lens side surface 1d even in the position-adjustment range of the first lens 1.

In the embodiment, the position-adjustment in the axial direction is performed without extracting the first lens 1 from the fitting surface 33d upon position-adjustment of the first lens 1.

In addition, in the lens unit 30, as shown in FIG. 10, the first lens 1 is adhered and fixed in a state in which the first lens 1 is fitted into the fitting surface 33d.

For this reason, the fitting surface 33d has a function as a positioning unit of the first lens 1 in the radial direction. That is, an inner diameter d4 (here, d1>d4>D1) of the fitting surface 33d is a dimension at which a maximum gap Δₘₐₓ with the lens side surface 1d blocks the adhesive agent 14, and is equal to or less than shift eccentricity allowed for the first lens 1.

The lens-holding hole inner circumferential surface 33b is constituted by a cylindrical surface having a diameter d5 (here, d5>d4) and formed concentrically with the reference axis C.

In the embodiment, the lens-holding hole inner circumferential surface 33b is not related to a maximum value of the position-adjustment range in the radial direction of the first lens 1. For this reason, the diameter d5 is set to a dimension that can hold the adhesive agent 14 required for fixing the first lens 1 between the lens-holding hole inner circumferential surface 33b and the lens side surface 1d of the first lens 1 fitted into the fitting surface 33d.

A length in the axial direction of the lens-holding hole inner circumferential surface 33b is set to a length in which an overlap with the lens side surface 1d occurs in the radial direction when seen from the radial direction within the adjustment range in the axial direction of the first lens 1.

The first lens 1 can be disposed inside the lens-holding hole inner circumferential surface 33b by a shape of the lens-holding hole inner circumferential surface 33b according to the embodiment within the position-adjustment range in the axial direction in a state in which the lens side surface 1d is opposite to the lens-holding hole inner circumferential surface 33b in the radial direction by a certain gap.

According to the lens frame 33 of the embodiment, similar to the first embodiment, the lens unit 30 can be manufactured by sequentially performing the lens frame-disposing process, a lens orientation-determining process, an adhesive agent holding process, a lens position-adjustment process and a lens-fixing process.

The lens frame-disposing process, the lens orientation-determining process and the adhesive agent-holding process of the embodiment are the same processes as the first embodiment except that the lens frame 33 is used instead of the lens frame 3.

In the lens position-adjustment process of the embodiment, like the first embodiment, the moving position-determination operation and the moving operation are performed. However, the moving position is determined within a range in which the first lens 1 is not pulled out of the fitting surface 33d while the axial direction reference surface 1c is separated from the axial direction reception section 3e. For this reason, when the first lens 1 is moved in the moving position, at least a portion of the lens side surface 1d is opposite to the fitting surface 33d, and a gap Δ is formed between the lens side surface 1d and the fitting surface 33d.

Accordingly, in the adhesive agent-holding process of the embodiment, an adhesive agent held between the lens side surface 1d and the lens-holding hole inner circumferential surface 33b has a distribution shape like an adhesive agent 14B shown in FIG. 10 when the first lens 1 is moved. That is, a portion of the adhesive agent 14B is moved together with the lens side surface 1d to be pulled upward when the first lens 1 is moved. However, the adhesive agent 14B is blocked by the fitting surface 33d not to move downward when the first lens 1 is moved.

When the moving position-determination operation and the moving operation are performed one time or more and the first lens 1 is moved to the moving position at which the optical characteristics as the lens unit 30 are satisfied, the lens position-adjustment process is terminated.

Next, the lens-fixing process according to the embodiment is performed. The process is the same process as that of the first embodiment except that the adhesive agent 14B is cured because the lens frame 33 is used instead of the lens frame 3 according to the first embodiment.

The lens-fixing process differs from that of the first embodiment in that the adhesive agent 14B held in a gap S″ surrounded by the lens side surface 1d, the plane portion 3c and the lens-holding hole inner circumferential surface 33b is cured by receiving UV light from the UV light source 8, and an adhesive agent curing body 4B as shown in FIG. 10 is formed.

As a result of the process, the first lens 1 is fixed to the lens frame 33 and the lens unit 30 is manufactured.

According to the embodiment, like the first embodiment, the adhesive agent is applied in a state in which orientation of the first lens 1 is determined, the orientation-determined first lens 1 is moved parallel to the axial direction to perform position-adjustment of the first lens 1, and then, the adhesive agent curing body 4B can be formed. Accordingly, when the first lens 1 is assembled to the lens frame 33 by adhesion, the position-adjustment in the axial direction of the first lens 1 can be precisely performed by a simple configuration without using, for example, a spacer tool or the like configured to perform orientation determination.

In the embodiment, since the adhesive agent is not attached to the axial direction reception section 3e, for example, even when the position-adjustment is restarted, precise orientation determination can be performed.

In the description of the embodiments and the first modification, as an example, the case in which the first lens 1 is adhered and fixed after the second lens 2 is fixed to the lens frame has been exemplarily described. However, as the axial direction reception section, the adhesive agent guide surface and the adhesive agent-blocking section having the same configurations as the first end portion E1 are also formed at the second end portion E2, the second lens 2 can be fixed similarly to the first lens 1.

When one or more lens or lens group is disposed between the first lens 1 and the second lens 2, such a lens or lens group can be fixed with respect to the lens frame like the first lens 1.

In the description of the embodiments and the first modification, while the case in which the position-adjustment of the first lens 1 is performed after the second lens 2 is fixed to the lens frame has been exemplarily described, in a state in which the second lens 2 is not fixed, position-adjustment in the axial direction or the radial direction of the first lens 1 with respect to the lens frame 3 may be performed.

In the description of the embodiments and the first modification, while the case in which the first lens 1 is adhered to the adhesive agent guide surface and the adhesive agent-blocking section and the example in which the first lens 1 is adhered to the adhesive agent guide surface have been exemplarily described, when the lens is fixed to the lens frame, the adhesive agent may be adhered only to the adhesive agent-blocking section. That is, the lens may be adhered to at least one of the adhesive agent guide surface and the adhesive agent-blocking section.

All of the components described in the embodiments and the first modification may be appropriately assembled or deleted and then performed without departing from the technical spirit of the present invention.

For example, in the second embodiment, when the position-adjustment of the first lens 1 is performed, the position-adjustment in the radial direction of the first lens 1 may also be performed within the range of the gap between the lens side surface 1d and the fitting surface 33d. In this case, as the position-adjustment in the radial direction of the first lens 1 is also performed, better optical performance can be realized.

Such modification is particularly appropriate when the maximum gap Δₘₐₓ for blocking the adhesive agent 14 is increased, for example, as the adhesive agent 14 having high viscosity is used.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A lens frame configured to dispose a lens on a reference axis and fix the lens using an adhesive agent in a state in which a position of the lens is adjusted in an axial direction along at least the reference axis, the lens frame comprising:
an axial direction reception section configured to abut the lens in the axial direction and separated from the lens upon fixing of the lens in order to define an orientation of the lens with respect to the reference axis;
an adhesive agent guide surface configured to form a gap through which the adhesive agent is introduced between a side surface of the lens and the adhesive agent guide surface in a radial direction perpendicular to the reference axis; and
an adhesive agent-blocking section formed between the adhesive agent guide surface and the axial direction reception section in the axial direction, fitted onto the side surface of the lens in the radial direction when the lens abuts the axial direction reception section, and configured to block the adhesive agent such that the adhesive agent introduced into the gap does not flow into the axial direction reception section.

2. The lens frame according to claim 1, wherein the adhesive agent guide surface is formed such that a region in the axial direction overlaps the side surface of the lens in a position-adjustment range of the lens in the axial direction, when seen from the radial direction, and
the axial direction reception section is formed at a position separated from the lens within the position-adjustment range of the lens in the axial direction.

3. A lens assembly, comprising:
the lens frame according to claim 1; and
a lens disposed to be spaced from the axial direction reception section of the lens frame in the axial direction and adhered to at least one of the adhesive agent guide surface and the adhesive agent-blocking section of the lens frame.

4. A lens assembly, comprising:
the lens frame according to claim 2; and
a lens disposed to be spaced from the axial direction reception section of the lens frame in the axial direction and adhered to at least one of the adhesive agent guide surface and the adhesive agent-blocking section of the lens frame.

5. A method of manufacturing a lens assembly including disposing a lens on a reference axis of a lens frame and fixing the lens to the lens frame using an adhesive agent in a state in which a position of the lens is adjusted in an axial direction along at least the reference axis,
the lens frame having an axial direction reception section configured to abut the lens in the axial direction, an adhesive agent guide surface having a gap through which the adhesive agent is introduced between a side surface of the lens and the adhesive agent guide surface in a radial direction perpendicular to the reference axis, and an adhesive agent-blocking section fitted onto the side surface of the lens in the radial direction and configured to block the adhesive agent such that the adhesive agent introduced into the gap does not flow into the axial direction reception section, and
the method of manufacturing the lens assembly comprising:
a lens frame-disposing process of disposing the lens frame to be arranged in sequence of the adhesive agent guide surface, the adhesive agent-blocking section and the axial direction reception section from an upper side;
a lens orientation-determining process of performing orientation determination of the lens with respect to the reference axis as the lens abuts the axial direction reception section while fitting the side surface of the lens into the adhesive agent-blocking section;
an adhesive agent-holding process configured to introduce the adhesive agent into a gap between the side surface of the lens and the adhesive agent guide surface and hold the adhesive agent blocked by the adhesive agent-blocking section in the gap;
a lens position-adjustment process of performing position-adjustment of the lens in the axial direction along at least the reference axis as the lens is separated from the axial direction reception section to move in parallel; and
a lens-fixing process of fixing the lens to the lens frame by curing the adhesive agent in a state in which a position and orientation of the lens that passed the position-adjustment are held.

6. The method of manufacturing the lens assembly according to claim 5, wherein, in the lens position-adjustment process, when the lens is moved above the adhesive agent-blocking section, the position of the lens is adjusted in the axial direction and the radial direction.
